(19) United States
(12) Patent Application Publication
(10) Pub. No.: US 2007/0221603 A1
(43) Pub. Date: Sep. 27, 2007

(54) Baby Bottle With Side by Side and Attached Compartments

(76) Inventor: Kimberly Moss, Chicago, IL (US)

Correspondence Address: DENISON & ASSOCS. PC, 212 W. WASHINGTON ST, #2004, CHICAGO, IL, 60606, US

(21) Appl. No.: 11/277,487

(22) Filed: Mar. 24, 2006

(51) Int. Cl. B65D 1/04; A61J 11/00; B65D 23/12

(52) U.S. Cl. 215/11.1; 215/6; 215/386

(57) ABSTRACT

The present invention comprises an improved infant feeding device with two feeding reservoirs wherein it is provided with opposing open circular ends with outwardly or extending circular tubes wherein a baby may be fed from either end of the device and from either chamber. Each feeding reservoir is provided with a semicircular end wall located adjacent opposing ends of the device. In use, one end is provided with an end cap, while the other end is provided with a nipple and nipple retainer ring. This allows baby to feed from either end of the device. In an additional preferred embodiment, a dual side by side chambered baby bottle is provided with two substantially semi-cylindrical feeding reservoirs. In yet an additional preferred embodiment of the device, two feeding chambers are provided which are threadingly secured to one another, allowing a food jar to be removably detached from a baby bottle fluid reservoir. The use of such a device permits a caretaker to simply and easily store two food items in one device, allowing for easy storage and retrieval from a diaper bag.

### FIELD OF THE INVENTION

The present invention relates to the areas of baby bottles having multiple compartments, or those which have removably attached multiple compartments, to allow for packing multiple infant food and drink items in a single device.

### BACKGROUND OF THE INVENTION

Parents with infants are extremely busy with the time consuming task of taking care of baby. Any trip from home involves the Herculean task of assembling together numerous items specialized for a baby. Not only will a diaper bag typically contain a half dozen or so diapers, but it will also contain lotions, ointments, extra clothes, bibs and a great number of other paraphernalia that baby will need, or might need. As a result, finding anything in a diaper bag can be quite a task, and it generally occurs while the infant is fussing mightily. Feeding time can often be stressful, because while a baby whales, a parent is scrounging the diaper bag for a bottle, ajar or two of food, and a spoon, if needed. If all of these items could be combined together, this could greatly simplify the task of mealtime for baby.

A number of patents have been uncovered in the prior art which pertain to the field of baby bottles. One such patent is U.S. Pat. No. 6,257,429 issued to Kong, this patent discloses a baby bottle with an upper chamber for one type of liquid and another lower chamber for another type of liquid wherein the lower chamber dispenses liquid to the nipple of the bottle through an extension piece or tube. Another related patent is U.S. Pat. No. 6,116,439 issued to Yanni which discloses a multichambered baby bottle with ring collars and tubular segments which can make the bottle as long as the user desires to utilize different quantities of fluid. However these rings are not securement devices for both standard baby food jars and larger food compartments.

Another patent related to this field is U.S. Pat. No. 6,089,389 issued to I. Sharon which discloses the use of a baby bottle with an upper chamber which is used to store the milk powder and a lower chamber for storing the fluid wherein after the two are mixed together the upper chamber is no longer used and the mixed milk may be dispensed. Likewise, U.S. Pat. No. 5,401,200 issued to I. Ellis discloses the use of a baby bottle formed of separate segments which can be put together and matched for forming an educational and/or decorative baby bottle for amusement of baby.

Baby bottles having attachments designed to cover the nipple cap of a bottle are shown in U.S. Pat. No. 5,361,918 issued to T. Mason. Baby bottles having integral multiple chambers for infant formula powder are illustrated in U.S. Pat. No. 4,979,629 issued to Askerneese. This patent discloses the use of two such chambers.

U.S. Pat. No. 4,603,784 issued to Chang which discloses the use of a back-to-back nursing bottle configuration where bottles are joined like Siamese twins, end to end. U.S. Pat. No. 4,600,111 issued to Brown discloses a toddler drinking cup with an upper portion for a first liquid for drinking, and then a second compartment directly therebeneath for storing additional liquids. U.S. Pat. No. 4,078,686 issued to Karesh discloses a patent for a two way jar with removable inserts wherein the jars are back to back. U.S. Pat. No. 2,843,281 issued to Gallois discloses the use of a bottle which has a lower flange which may connect a lower chamber to the bottom of a baby bottle.

Another interesting patent related to this general field is U.S. Pat. No. 1,064,442 which discloses the use of a jug with a cork on top of ajar which is secured to the bottle bottom by means of a flange.

There are also a few design patents in this field, most notably, U.S. Des. Pat. No. 404,822 which shows the uses of a segmented baby bottle having internal segments with apertures at the top and bottom and a final bottom segment which has a solid bottom. In a similar manner, U.S. Des. Pat. No. 342,574 discloses the use of a back-to-back mirror image baby bottle system, further having a design and graduated ounce markings on each bottle. The bottles are further integral to one another.

However, no where in the prior art is seen a baby bottle having multiple side by side compartments for two types of liquids such as juice and milk. Nor is there seen in the prior art an infant food receptacle which is capable of removably securing either a standard baby food jar and/or a large baby food container by providing two concentric threaded rings at its lower end to conveniently transport both a bottle for dispensing liquid to an infant, while at the same time retaining a container or baby food jar.

### SUMMARY OF THE INVENTION

The present invention consists of a baby bottle having dual side by side compartments for retaining infant foods and liquids, such as soft baby food, juice, milk, soup and the like. The entire bottle portion is shaped with a central pair of outwardly extending tubes creating a structure which is easy for baby to grasp during feeding. In one preferred embodiment of the present invention, the central tubes are truncated at opposing ends, creating an aesthetically pleasing appearance. In a further embodiment, the tubes are truncated at the same end, creating a separate cup shaped compartment for soup or baby food. In yet an additional preferred embodiment of the present invention, two tubes are constructed in side by side fashion, each having outwardly extending central sections, with the terminal shapes of each tube being semicircular so they nest together with an outer circular form which is adapted to threadingly secure to a baby bottle nipple.

In still a further preferred embodiment of the present invention, a standard baby bottle is provided having a nipple, a threaded nipple retainment ring at its top end, a substantially elongate fluid reservoir for milk, juice, or a variety of liquids commonly fed to an infant, with the reservoir further being provided at its lower end with threaded securement means for either a standard baby food jar, or a larger compartment which can removably retain common snacks for baby such as cereals, soft fruits, canned cut up fruits, soups, and other foods typically fed to babies.

Means for securing a spoon may also be provided along the side of the improved baby bottle. In such a manner, it would be very simple for the infant's caretaker to place milk or formula in a bottle, take off the top of a baby food jar, and simply screw it onto the lower portion of the bottle, secure a spoon as needed to the side of the bottle, and then place the entire assembly into a diaper bag for ready retrieval at feeding time. Instead of having to pack two milk bottles, two juice bottles, and two cereal jars, this enable s the caretaker to only carry three bottles in a diaper bag, which is much easier.

Or these units can be assembled one on top of the other separately, so that they can be easily found and retrieved in a diaper bag. Of course, the types of diaper bags that have baby bottle pockets in them, either on the outside or inside, are best for removably securing the bottle/jar assembly, or multiple jar/compartment assemblies for simple retrieval and feeding.

It is anticipated that the baby bottle portion of the improved infant feeding device is made from a hard plastic which may or may not be clear. It may or may not be made from different colored molded units which may provide entertainment to the baby as she drinks or feeds. The securement device for the baby food jar or compartment may either be separate from the baby bottle, or it may be integral to it. In one preferred embodiment, the jar securement means consists of a separate plastic ring which merely snaps onto the bottom of the baby bottle, although other securement methods common know in the art may be readily employed as well. The separate food container also may be made from a substantially rigid copolymer which may or may not be clear, as desired by the user.

### OBJECTS OF THE PRESENT INVENTION

Therefore, it is one primary object of the present invention to provide an improved baby bottle construction having dual chambers with a central portion consisting of two tubes which flare outwardly, allowing an infant to easily grasp the bottle.

It is a further primary object of the present invention to provide an improved baby bottle construction having dual chambers with a central portion consisting of two tubes which flare outwardly which terminate at either end in order to provide an aesthetically pleasing appearance to the invention.

Still an additional primary object of the present invention is to provide an improved baby bottle construction having dual side by side semi-cylindrical chambers, wherein the opposing ends have are provided with semi-circular walls so that either end of the device may be used for feeding.

An additional primary object of the present invention is to provide an improved baby bottle and food jar assembly wherein the food jar may be threadingly received at the bottom end of the baby bottle.

It is an additional primary object of the present invention to provide an improved baby bottle and food jar assembly wherein a standard size food jar may simply have its top removed and then resecured threadingly again onto the bottom of a baby bottle.

It is yet a primary object of the present invention to provide an improved baby bottle and food jar assembly wherein a separate container may also be secured onto the bottom portion of a baby bottle.

It still another primary object of the present invention to provide an improved baby bottle and food jar assembly wherein a standard sized baby food jar may simply have its top removed so that it may be threadingly secured to the bottom of a food container.

An additional primary object of the present invention is to provide a jar/container securement device consisting of a plastic ring which can be snapped onto the bottom of a baby bottle, or it may be snapped onto the bottom of a small food container.

Still a further primary object of the present invention is to provide an improved baby bottle having food jar/securement means which is integral to its bottom portion.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 shows a front perspective view of the present invention showing a preferred embodiment with dual chambers and a central portion with outwardly extending or flared tubes each of which terminate in a substantially elliptical endwalls.

FIG. 2 shows a front perspective blown apart view of one preferred embodiment of the present invention which is provided with two semi-cylindrical feeding reservoirs in a side by side arrangement.

FIG. 3 shows a front perspective view of a preferred embodiment of the present invention which is provided with two feeding reservoirs which are substantially semi-circular at each end, which then tapers into a substantially oval or circular form in the central portion of the bottle and which central tube portion flares outwardly.

FIG. 4 shows a front perspective view of the present invention wherein a baby bottle with a plastic ring to secure a baby food jar has been provided.

FIG. 5 shows a lower cross section of the ring shown in FIG. 1 wherein a threaded upper opening has been provided for a baby bottle, and two concentric lower threaded rings have been provided for either a baby food jar or a food container.

FIG. 6 shows a cross section of a low portion of a snap on type ring which is adapted to secure to the lower portion of a baby bottle which has been provided with an annular protrusion or bump, while the lower portion of the jar/container securement ring has been provided with two concentric threaded apertures which are adapted to removably secure either a baby food jar or a food container.

FIG. 7 shows yet a an additional preferred embodiment of the present invention in front perspective view wherein the threaded jar/container securement device is integral to the baby bottle design, an a baby spoon holder has also been provided.

FIG. 8 shows a partial cross section of the lower portion of the integral baby bottle design wherein a baby food jar has been threadingly received into the lower portion of the baby bottle.

FIG. 9 shows a partial cross section of a food container which has an additional food jar/container securement device provided in its lower portion.

### DETAILED DESCRIPTION OF THE DRAWINGS

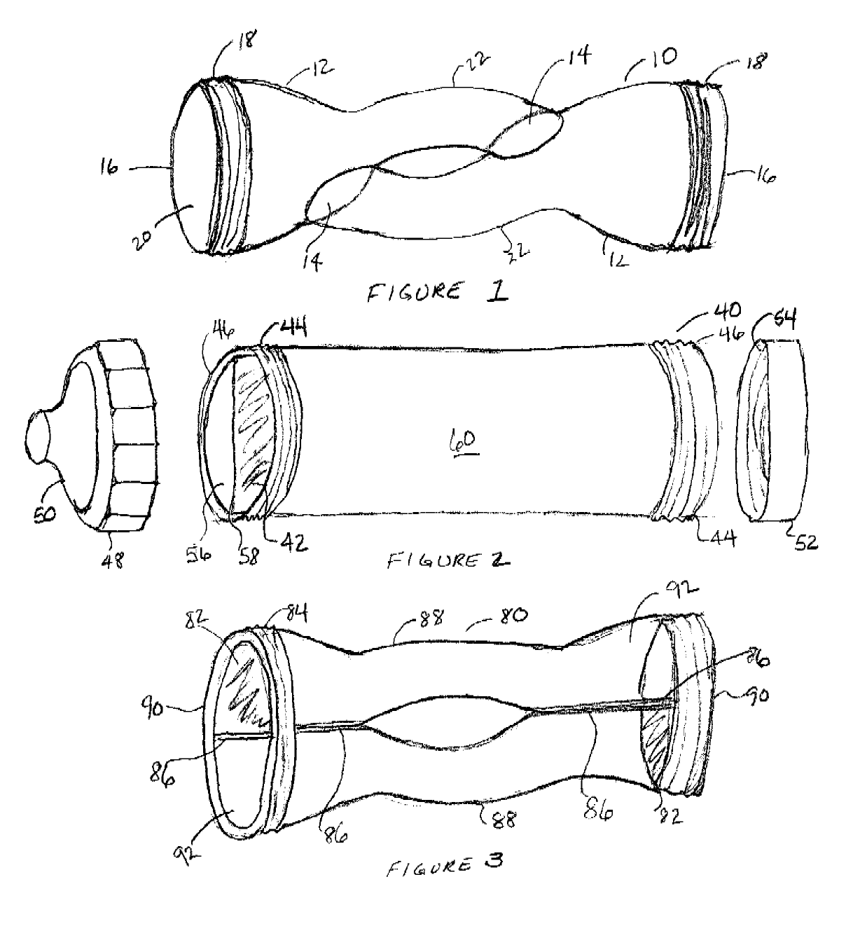

FIG. 1 shows improved infant feeding device 10 which has been provided with dual opposed openings 16 which provide access to food or liquid reservoirs 20. Openings 16 are provided with exterior threads 18 so that they may accommodate a standard sized nipple and nipple retainer ring, or an end cap when the device is not in use. Dual opposing reservoirs 20 terminate in end walls 14. Outwardly extending or flared tubes 22 make infant feeding device 10 easy for an infant to grasp. Of course end walls 14 may be placed at any point along the length of tubes 22, and when they are both positioned nearest the cup shaped portion 12 of reservoirs 20, this will create a large space to accommodate fluids and a smaller space to accommodate a soft baby food. In this particular instance, the infant feeding device 10 is made from a clear, substantially rigid copolymeric material, although it may be made from a material which is either opaque or semi-opaque. When the material is opaque or semi-opaque, it is easier to determine when the drink item contained therein has been depleted. Further when the material is translucent, it may be colored, with each reservoir being a separate color to create an aesthetically pleasing design.

FIG. 2 shows a blow apart view of infant feeding device 40 which has been provided with dual opposed openings 46. A central wall 58 extending the length of bottle body 60 creates two substantially semi-cylindrical food or drink reservoirs 56, each of which has been closed off with one semi-circular end wall 42 positioned nearest each opening 46. The exterior ends of infant feeding device 40 have each been provided with exterior threads 44 which are adapted to threadingly and removably secure either a nipple retainer ring 48 and nipple 50 thereto, or an end cap 52 may be secured thereto. End cap 52 has been provided with interior threads 54 to secure end cap 52 to bottle body 60.

FIG. 3 shows yet an additional preferred embodiment of the present invention, infant feeding device 80 which has been provided with two oval or circular outwardly extending central tubes 88 which are easy for an infant to grasp. Extending the length of infant feeding device 80 is central wall 86. Near each opening 90 of infant feeding device 80 is an end wall 82 which has been provided to create two independent food or drink reservoirs 92. Exterior threads 84 have been provided to secure a nipple assembly or end cap thereto. Such a design simplifies the packing of two food or drink items for parents, while at the same time, allowing baby to grasp the device easily.

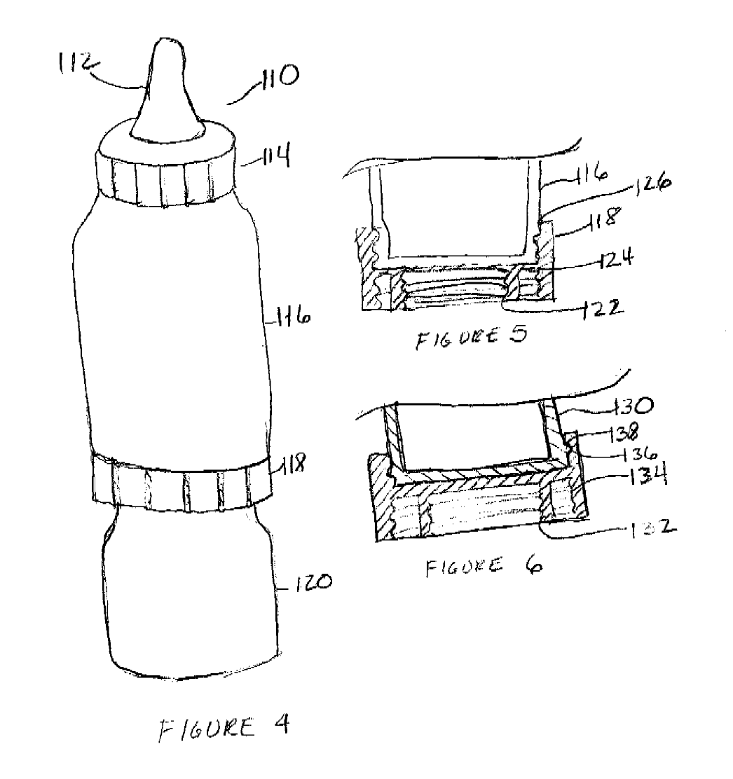

FIG. 4 shows improved baby bottle/container assembly having improved baby bottle/container device 110 which has been provided with nipple 112, at its upper portion which is secured to bottle fluid reservoir 116, by means of nipple securement ring 116. A baby food jar 120, has been removably threadingly secured into the lower portion of jar/container securement ring 118.

FIG. 5 is a partial lower cross section of a baby bottle having fluid reservoir 116 which has been removably threadingly received into upper threaded aperture 126 of jar/container securement ring 118. In the lower portion of jar/container securement ring 118, has been provided two concentric threaded rings, the first of which, inner concentric threaded aperture 122 that has been provided to accommodate the smaller opening of a baby food jar, while outer concentric threaded aperture 124 has been provided to accommodate a larger mouth opening for a food container.

FIG. 6 is a partial lower cross section of an additional preferred embodiment of the present invention showing a baby bottle fluid reservoir 130 which has been provided with an annular bump or protrusion 136 along its lower portion, which is adapted to be removably slidingly received into the upper portion of jar/container securement ring 138.

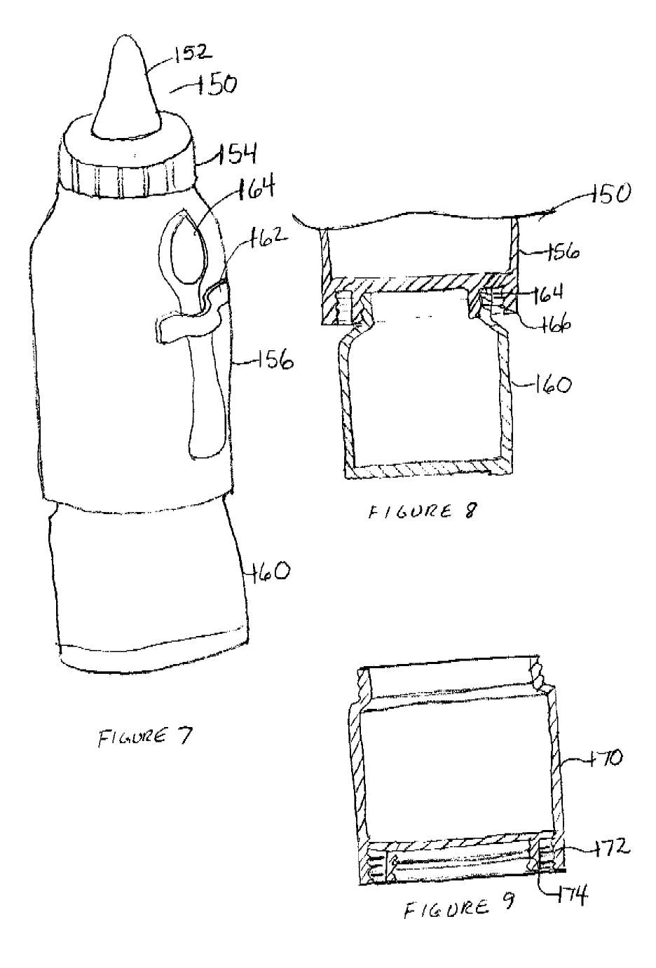

FIG. 7 shows yet an additional preferred embodiment of the present invention, improved baby bottle container securement device 150 wherein the jar/container securement means is integral to the baby bottle portion, fluid reservoir 156. Show in this figure is nipple 152 which is retained by nipple retainer ring 154. Along the exterior of fluid reservoir 156 is also show baby flatware retainer 162 which is holding a baby spoon 164.

FIG. 8 shows a partial cross section of the lower portion of improved baby bottle container securement device 150 which has been provided with standard baby food jar 160 by removably securing into inner threaded concentric ring 66. An outer concentric threaded ring 164 is also provided, should the user decide to remove baby food jar 160 and instead install a larger food jar onto the bottom of improved baby bottle container securement device 150.

FIG. 9 shows an elevation cross section of food container 70 which is provided at it lower portion with two concentric threaded rings, outer concentric threaded ring which is adapted to receive yet an additional food container, such as food container 70, while inner concentric threaded ring 74 is adapted to threadingly receive and secure a standard sized baby food jar thereto.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. An improved baby bottle infant feeding device having;
two side by side feeding chambers comprising a bottle body;
two substantially semi-circular end walls each located adjacent the opposing ends of each feeding chamber;
an end cap having interior threads which may be threadingly secured to either end of the bottle body;
a nipple and nipple ring for securing the nipple to either end of the bottle body, wherein the baby may be fed from either end of the bottle body.

2. The improved infant feeding device of claim 1 wherein the bottle body has a central portion and the central portion comprises two outwardly extending curved tubes which allow an infant to easily grasp the feeding device.

3. The improved infant feeding device of claim 1 wherein the two side by side feeding chambers are each substantially semi-cylindrical in form.

4. The improved infant feeding device of claim 1 wherein further having;
opposing substantially cup shaped end portions;
a central portion wherein the central portion comprises two outwardly extending tubes which allow an infant to easily grasp the feeding device.

5. The improved infant feeding device of claim 4 further having two end walls, wherein one end wall each is located adjacent the cup portion of each end of the cup shaped end portions creating two mirror image opposing feeding chambers.

6. The improved infant feeding device of claim 4 further having two end walls, wherein both end walls are located adjacent the cup portion of one cup thereby creating one larger feeding chamber and one smaller feeding chamber.

7. An improved baby bottle and container assembly having:
a nipple, a threaded nipple securement ring, a substantially cylindrical fluid chamber secured to the nipple securement ring; the fluid chamber being provided with dual concentric threaded means at its lower end to receive either a standard size baby food jar, or food container with a larger threaded opening.

8. The improved baby bottle and container assembly of claim 7 further having an exterior portion for its fluid chamber, and the exterior portion is further provided with means to secure a piece of flatware thereto.

9. The improved baby bottle and container assembly of claim 7 wherein the means to receive either a standard size baby food jar or a food container comprises a copolymeric ring having an upper opening and two lower concentric threaded apertures.

10. The improved baby bottle and container assembly of claim 7 wherein the means to receive either a standard size baby food jar or a food container has two lower concentric threaded apertures which are integral to the fluid reservoir.

10. The improved baby bottle and container assembly of claim 7 further having a lower portion, wherein the lower portion is provided with two threaded concentric apertures adapted to removably secure either a second improved jar or container, or it may secure to a standard baby food jar.

11. The improved baby bottle and container assembly of claim 7 which has a fluid reservoir that has been constructed from a rigid, clear copolymer.

12. The improved baby bottle and container assembly of claim 7 which has a fluid reservoir that has been constructed from a substantially opaque copolymer.

13. The improved baby bottle and container assembly of claim 7 wherein the fluid reservoir is further provided with a lower portion, and the lower portion has been provided with exterior threading which is adapted to be removably received within the copolymeric ring.

14. The improved baby bottle and container assembly of claim 3 wherein the fluid reservoir is further provided with a lower portion, and the lower portion has been provided with an annular protrusion which is adapted to be removably received within the copolymeric ring.
